(19) United States
(12) Patent Application Publication
(10) Pub. No.: US 2007/0059404 A1
(43) Pub. Date: Mar. 15, 2007

(54) Ice cream and ice cream formulations containing maltitol

(75) Inventors: Ronald C. Deis, West Chester, PA (US); Charles E. Kuenzle, Newark, DE (US); Bruce W. Tharp, Villanova, PA (US)

Correspondence Address: CONNOLLY BOVE LODGE & HUTZ, LLP, P O BOX 2207, WILMINGTON, DE, 19899, US

(73) Assignee: SPI Polyols, Inc., New Castle, DE (US)

(21) Appl. No.: 11/499,339

(22) Filed: Aug. 4, 2006

Related U.S. Application Data
(63) Continuation-in-part of application No. 11/034,029, filed on Jan. 12, 2005.
(60) Provisional application No. 60/536,062, filed on Jan. 13, 2004.

(51) Int. Cl. A23G 9/00

(52) U.S. Cl. 426/101; 426/548

(57) ABSTRACT

The present invention relates to ice cream formulations containing maltitol and ice cream made therefrom.

### CROSS-REFERENCE TO RELATED PATENT APPLICATIONS

The present application is a continuation-in-part of U.S. patent application Ser. No. 11/034,029, which was filed on Jan. 12, 2005. The present application also claims the benefit of the Jan. 13, 2004, filing date of U.S. provisional application Ser. No. 60/536,062. The complete disclosures of U.S. patent application Ser. No. 11/034,029 and U.S. provisional application Ser. No. 60/536,062 are hereby expressly incorporated herein by reference.

### BACKGROUND OF THE INVENTION

1. Field of the Invention

The present invention relates to ice cream formulations containing maltitol and ice cream made therefrom.

2. Description of the Related Art

Maltitol is a polyol that is produced from the catalytic hydrogenation of high maltose corn syrup. Maltitol has approximately 90 percent of the sweetness of sugar and is generally recognized to have a caloric value of about 2.1 kcal/g. Products sweetened with maltitol meet the FDA's definition of “no sugar added” or “sugarless.” These properties allow maltitol to be used as a reduced-calorie sweetener in the United States. Maltitol is relatively slowly absorbed by the human digestive system, yet has a Taxation threshold that is about two times that of sorbitol. Maltitol also has a heat of solution comparable to sucrose, making it a popular sugar-free substitute sweetener. Maltitol is commonly used in candies, chewing gum, chocolates, jams and jellies, and frozen desserts.

Maltitol has a pleasant sweet taste and because maltitol has a relative sweetness value of 90, for most applications there is no need to adjust the sweetness. Unlike sorbitol, maltitol does not exhibit a strong cooling effect. Maltitol also has very good heat stability, which means that it can be handled at high temperature without decomposition or color formation. Due to the nature of maltitol and the virtual absence of reducing sugars, maltitol can be concentrated to very high dry substance levels without unwanted discoloration or browning reactions. Maltitol also has excellent humectancy capacity due to its hygroscopic character.

Hydrogenated mono-, di-, oligo- and poly-saccharides are characterized by the degree of polymerization (DP) after hydrogenation. Hydrogenated monosaccharides have a DP=1 (e.g., sorbitol and mannitol). Hydrogenated disaccharides have a DP=2 (e.g., maltitol). Hydrogenated tri-, quat-, penta-, hexa-, hepta-, octa-, nona-, and deca-saccharides have DPs of 3, 4, 5, 6, 7, 8, 9, and 10, respectively. Hydrogenated undeca-and greater saccharides have DPs of 11 or greater. The DP (which is also sometimes referred to as “HP”) may be determined by routine HPLC analysis.

Generally, the term hydrogenated starch hydrolysate can correctly be applied to any polyol produced by the hydrogenation of the saccharide products of starch hydrolysis. In practice, however, certain polyols such as sorbitol, mannitol, and maltitol are referred to by their common chemical names. “Hydrogenated starch hydrolysate” is more commonly used to describe the broad group of polyols that contain substantial quantities of hydrogenated oligo- and polysaccharides in addition to any monomeric or dimeric polyols (sorbitol/mannitol or maltitol, respectively).

U.S. Pat. No. 4,675,200 to Serpelloni et al. (“the '200 patent”), which is hereby incorporated by reference, describes sugarless ice cream containing a polyol content of DP equal to or higher than three (3) of more than 2% and less than 15% by weight with respect to dry matter in the finished product. Although the ice cream compositions of this patent are said to be sugarless, they may contain small amounts of lactose (less than 1% by weight of the dry matter in the ice cream). To obtain the aforementioned ice cream having the desired polyol content of DP equal to or higher than three, the '200 patent teaches that certain HSH's can be used in the formulations from which the ice creams are prepared. These HSH's are said to contain sorbitol in amounts of from 0.1 to 35% and maltitol in amounts of from 8 to 80% by weight, with the remainder to 100% being polyols of DP greater than or equal to 3, all percents by weight based on the dry matter in the HSH. However, the only example of such an HSH provided in the '200 patent has a very specific composition, 7.0% sorbitol, 52.5% maltitol, 18% DP 3, 21.5% DP 3 to 20 and 1% DP greater than 20 (all percents by weight of the dry matter in the HSH). All of the ice creams actually made in the patent contain aspartam (aspartame) as a high-intensity sweetener. The use of high-intensity sweeteners in these ice cream formulations helps to reduce the amount of the polyols that must be incorporated into the ice creams to replace the sweetness component that was formerly provided by the sugars in the ice creams. This is important to ice cream formulations like those described in the '200 patent, because the use of certain polyols or polyol mixtures (like the ones actually used in the examples of the '200 patent) can result in a lowering of the freezing point of the ice creams, which has a detrimental effect on the properties of the ice cream (e.g., the firmness of the ice cream and the speed at which the ice cream melts at normal serving temperatures). The lowering of the freezing point is increased as more of the polyols are used in the ice cream formulations. Thus, the use of high-intensity sweeteners, which reduces the amount of the polyols (i.e., HSH) that must be used to achieve a given level of sweetness in the ice cream, is an important or even essential part of the invention described in the '200 patent.

### SUMMARY OF THE INVENTION

One aspect of the present invention is an ice cream formulation that comprises any of the following separate embodiments:
(1) a) fat in an amount of from 0 to 15% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(2) a) fat in an amount of from 0.5 to 15% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(3) a) fat in an amount of from 1 to 15% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(4) a) fat in an amount of from 2 to 15% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(5) a) fat in an amount of from 4 to 15% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(6) a) fat in an amount of from 6 to 12% by weight (based on total weight of the ice cream formulation);
   b) non-fat milk solids in an amount of from 7 to 12% by weight (based on total weight of the ice cream formulation); and
   c) maltitol in an amount of from 30 to 45% by weight (based on the weight of the dry solids in the ice cream formulation).
(7) a) fat in an amount of from 8 to 12% by weight (based on total weight of the ice cream formulation);
   b) non-fat milk solids in an amount of from 8 to 10% by weight (based on total weight of the ice cream formulation); and
   c) maltitol in an amount of from 30 to 45% by weight (based on the weight of the dry solids in the ice cream formulation).

A second aspect of the present invention is an ice cream formulation that comprises any of the following separate embodiments:
(1) a) fat in an amount of from 0 to 8% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).
(2) a) fat in an amount of from 0.5 to 8% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).
(3) a) fat in an amount of from 1 to 7% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).
(4) a) fat in an amount of from 2 to 7% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).
(5) a) fat in an amount of from 2 to 6% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).
(6) a) fat in an amount of from 1 to 5% by weight (based on total weight of the ice cream formulation);
   b) non-fat milk solids in an amount of from 7 to 12% by weight (based on total weight of the ice cream formulation); and
   c) maltitol in an amount of from 20 to 45% by weight (based on the weight of the dry solids in the ice cream formulation).
(7) a) fat in an amount of from 1 to 4% by weight (based on total weight of the ice cream formulation);
   b) non-fat milk solids in an amount of from 8 to 10% by weight (based on total weight of the ice cream formulation); and
   c) maltitol in an amount of from 20 to 45% by weight (based on the weight of the dry solids in the ice cream formulation).
(8) a) fat in an amount of from 0 to 2% by weight (based on total weight of the ice cream formulation);
   b) non-fat milk solids in an amount of from 7 to 12% by weight (based on total weight of the ice cream formulation); and
   c) maltitol in an amount of from 20 to 45% by weight (based on the weight of the dry solids in the ice cream formulation).
(9) a) fat in an amount of from 0 to 4% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).

A third aspect of the present invention is an ice cream formulation that comprises any of the following separate embodiments:
(1) a) fat in an amount of from 0 to 8% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(2) a) fat in an amount of from 0.5 to 8% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(3) a) fat in an amount of from 1 to 7% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(4) a) fat in an amount of from 2 to 7% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(5) a) fat in an amount of from 2 to 6% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(6) a) fat in an amount of from 1 to 5% by weight (based on total weight of the ice cream formulation);
   b) non-fat milk solids in an amount of from 7 to 12% by weight (based on total weight of the ice cream formulation); and
   c) maltitol in an amount of from 30 to 45% by weight (based on the weight of the dry solids in the ice cream formulation).
(7) a) fat in an amount of from 1 to 4% by weight (based on total weight of the ice cream formulation);
   b) non-fat milk solids in an amount of from 8 to 10% by weight (based on total weight of the ice cream formulation); and
   c) maltitol in an amount of from 30 to 45% by weight (based on the weight of the dry solids in the ice cream formulation).
(8) a) fat in an amount of from 0 to 2% by weight (based on total weight of the ice cream formulation);
   b) non-fat milk solids in an amount of from 7 to 12% by weight (based on total weight of the ice cream formulation); and
   c) maltitol in an amount of from 30 to 45% by weight (based on the weight of the dry solids in the ice cream formulation).
(9) a) fat in an amount of from 0 to 4% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).

A fourth aspect of the present invention is an ice cream formulation that comprises any of the following separate embodiments:
(1) a) fat in an amount of from 9 to 15% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(2) a) fat in an amount of from 10 to 15% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(3) a) fat in an amount of from 11 to 15% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(4) a) fat in an amount of from 12 to 15% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(5) a) fat in an amount of from 9 to 14% by weight (based on total weight of the ice cream formulation);
   b) non-fat milk solids in an amount of from 6 to 12% by weight (based on total weight of the ice cream formulation); and
   c) maltitol in an amount of from 30 to 45% by weight (based on the weight of the dry solids in the ice cream formulation).
(6) a) fat in an amount of from 10 to 14% by weight (based on total weight of the ice cream formulation);
   b) non-fat milk solids in an amount of from 7 to 12% by weight (based on total weight of the ice cream formulation); and
   c) maltitol in an amount of from 30 to 45% by weight (based on the weight of the dry solids in the ice cream formulation).
(7) a) fat in an amount of from 10 to 13% by weight (based on total weight of the ice cream formulation);
   b) non-fat milk solids in an amount of from 8 to 10% by weight (based on total weight of the ice cream formulation); and
   c) maltitol in an amount of from 30 to 45% by weight (based on the weight of the dry solids in the ice cream formulation).

A fifth aspect of the present invention is an ice cream formulation that comprises any of the following separate embodiments:
(1) a) fat in an amount of from 9 to 15% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).
(2) a) fat in an amount of from 10 to 15% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).
(3) a) fat in an amount of from 11 to 15% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).
(4) a) fat in an amount of from 12 to 15% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).
(5) a) fat in an amount of from 9 to 14% by weight (based on total weight of the ice cream formulation);
   b) non-fat milk solids in an amount of from 6 to 12% by weight (based on total weight of the ice cream formulation); and
   c) maltitol in an amount of from 20 to 45% by weight (based on the weight of the dry solids in the ice cream formulation).
(6) a) fat in an amount of from 10 to 14% by weight (based on total weight of the ice cream formulation);
   b) non-fat milk solids in an amount of from 7 to 12% by weight (based on total weight of the ice cream formulation); and
   c) maltitol in an amount of from 20 to 45% by weight (based on the weight of the dry solids in the ice cream formulation).
(7) a) fat in an amount of from 10 to 13% by weight (based on total weight of the ice cream formulation);
   b) non-fat milk solids in an amount of from 8 to 10% by weight (based on total weight of the ice cream formulation); and
   c) maltitol in an amount of from 20 to 45% by weight (based on the weight of the dry solids in the ice cream formulation).

The ice cream formulations of the present invention can also comprise stabilizers, flavoring agents and other typical ingredients that are found in commercial ice cream.

When a stabilizer is present in the ice cream formulations of the present invention, it is usually present in an amount of from 0.1 to 0.5% by weight, based on the weight of the solids present in the ice cream.

On a dry solids basis, the ice cream formulations of the present invention which do not contain any high intensity sweeteners contain from about 20% by weight maltitol to about 45% by weight maltitol or from about 25% to about 45% by weight maltitol or from about 30% to about 45% by weight maltitol or from about 28% by weight maltitol to about 40% by weight maltitol or from about 30% by weight maltitol to about 38% by weight maltitol.

It is not necessary for the ice cream formulations of the present invention to contain high-intensity sweeteners and in many embodiments of the present invention, it is preferable that the ice cream formulations do not contain high-intensity sweeteners. However, in certain embodiments of the present invention, it can be desirable to include high-intensity sweeteners. In the ice cream formulations of the present invention which do contain high intensity sweeteners, the amount of maltitol can be reduced to levels that are below 20% by weight (dry solids basis). For example, depending on the amount of high intensity sweetener added, the ice cream formulations can contain from about 4% to 20% by weight maltitol (dry solids basis), preferably from about 5 to 15% by weight maltitol (dry solids basis). For example, in an ice cream formulation that contains about 85 ppm Sucralose, the maltitol content (on a dry solids basis) can be from about 4% to 10% by weight, preferably from 6 to 10% by weight. The amount of high-intensity sweetener(s) that can be added to the ice cream formulations of the present invention depends on the potency (level of sweetness) of the high intensity sweetener(s). Using sucralose (potency=600) as the standard for the high-intensity sweeteners, the amount of high-intensity sweetener (i.e., sucralose) that can be added to the ice cream formulations of the present invention (i.e., in this embodiment of the present invention, where high-intensity sweeteners are intentionally added to the ice cream formulations) is from about 5 ppm to 270 ppm, or 10 ppm to 240, or from 10 ppm to 200 ppm. The amounts of other high intensity sweeteners that can be used in the ice cream formulations of the present invention can be determined by taking into account their potency in comparison to sucralose. Obviously, as high-intensity sweetener is added, other sweeteners must be removed to maintain a comparable level of sweetness. Since the mass of the high-intensity sweetener is usually much less than the mass of the sweetener it is replacing (on an equivalent sweetness basis), it will usually be necessary to replace some of the mass that was lost by increasing the amounts of the other ingredients in the formulation. The final goal is to maintain the properties of the ice cream so that they are the same as, or comparable to, the properties of the ice cream before any high-intensity sweetener was added. In any event, the total amount of high-intensity sweeteners used should not be more than would be necessary to reduce the amount of maltitol in the ice cream formulation to below 4% by weight (dry solids basis), while maintaining a comparable level of sweetness in the ice cream. Preferably, the amount of high-intensity sweetener used in this embodiment of the present invention is not more than would be necessary to reduce the amount of maltitol in the ice cream formulation to below 6% by weight (dry solids basis), while maintaining a comparable level of sweetness in the ice cream. Table 1A, below, shows the relative potencies of some common high-intensity sweeteners as compared to sucrose (potency=1).

TABLE 1A

| Sweetener | Potency |
|---|---|
| Sucrose | 1 |
| Ace-K | 200 |
| Alitame | 2000 |
| Aspartame | 200 |
| Cyclamate | 30 |
| NHDC | 400 |
| Saccharin | 300 |
| Stevia | 200 |
| Sucralose | 600 |
| Thaumatin | 2000 |

In one embodiment of the present invention, the ice cream formulations contain no added sucrose. In another embodiment of the present invention, the ice cream formulations contain from 0.01 to 2% by weight added sucrose (based on the dry solids in the formulation). “Added sucrose” is sucrose that is separately added to the ice cream formulation (i.e., sucrose by itself—not part of another ingredient of the ice cream formulation). The amount of sucrose that may be present in the ice cream formulation is from 0 to 8% by weight, or from 0.5 to 8% by weight, or from 1 to 8% by weight, or from 2 to 8% by weight (all percents by weight based on the dry solids in the ice cream formulation).

In another embodiment of the present invention, the ice cream formulations contain no added sugars. “Added sugars” are sugars, other than sucrose or lactose, that are separately added to the ice cream formulation (i.e., sugars by themselves—not part of another ingredient of the ice cream formulation). Examples of these sugars are dextrose, fructose and glucose. The amount of sugars, other than sucrose or lactose, that may be present in the ice cream formulation is from 0 to 8% by weight, or from 0.5 to 8% by weight, or from 1 to 8% by weight, or from 2 to 8% by weight (all percents by weight based on the dry solids in the ice cream formulation).

The ice cream formulations of the present invention generally contain lactose in amounts of from 1 to 20% by weight, or from 2 to 20% by weight, or from 3 to 18% by weight, or from 4 to 18% by weight, or from 8 to 18% (all percents by weight based on the dry solids in the ice cream formulation).

The invention also concerns ice cream that is made from the aforementioned formulations, typically by subjecting the ice cream formulations to pasteurization, homogenization, and freezing (with aeration). The compositions of the ice creams made from the formulations of the present invention are usually the same as the compositions of the formulations that were used to make the ice creams (same percents by weight of each ingredient), excluding any extra ingredients that are added to the ice cream but are not part of the ice cream itself (such as pieces of fruit or candy).

### BRIEF DESCRIPTION OF THE DRAWINGS

FIG. 1 is a graph of the average molecular weight of the solids used as sweeteners in the ice cream formulations 1 to 7.

FIG. 2 is a graph showing the % overrun of the ice cream formulations 1 to 7 over time (minutes) as they are being aerated and frozen.

FIG. 3 is a graph showing the temperature of several ice cream formulations over time (minutes) as they are freezing.

FIG. 4 is a graph showing the density of several ice cream formulations prior to freezing and aeration.

FIG. 5 is a graph showing the % overrun of the ice cream formulations 1 to 4 over time (minutes) as they are being aerated and frozen.

FIG. 6 is a graph showing the % overrun of the ice cream formulations 1, 2, 5 and 6 over time (minutes) as they are being aerated and frozen.

FIG. 7 is a graph showing the % overrun of the ice cream formulations 1, 2 and 7 over time (minutes) as they are being aerated and frozen.

FIG. 8 is a graph showing the temperature of ice cream formulations 1 to 4 over time (minutes) as they are freezing.

FIG. 9 is a graph showing the temperature of ice cream formulations 1, 2, 5 and 6 over time (minutes) as they are freezing.

FIG. 10 is a graph showing the temperature of ice cream formulations 1, 2 and 7 over time (minutes) as they are freezing.

FIG. 11 is a graph showing the % overrun of the ice cream formulations 11 to 14 over time (minutes) as they are being aerated and frozen.

FIG. 12 is a graph showing the temperature of ice cream formulations 11 to 14 over time (minutes) as they are freezing.

### DETAILED DESCRIPTION OF THE INVENTION

The ice cream formulations of the present invention can be produced by the methods described below. While the methods described below are the preferred methods of producing the ice cream formulations of the present invention, they may not be the only methods. Accordingly, the described methods should be viewed as being illustrative and not necessarily limiting. Also, the formulations described below as examples of the present invention are provided to enable the reader to better understand the invention but not to limit the scope of the invention.

A 12% by weight fat ice cream formulation was prepared by first mixing the wet ingredients: 40% fat dairy cream (a heavy whipping cream), a maltitol syrup (Maltisweet™ IC—about 75% solids containing about 65% by weight maltitol) and water and then slowly adding the dry ingredients to the wet ingredients while mixing. The dry ingredients were non-fat dry milk solids (hereinafter “NFDMS”), sucrose, polydextrose or solid polyol (if used) and a stabilizer (microcrystalline cellulose—xp-3548 from FMC). When the dry ingredients included one or more dry sweeteners, such as sucrose, polydextrose and/or a solid polyol, the one or more dry sweeteners were the last solid ingredient(s) added to the formulation. After the addition of the dry ingredients, the formulation was mixed for 20 minutes with a high speed mixer to ensure that the formulation was homogeneous. After the mixing step, the formulation was pasteurized in a double boiler at about 160 degrees F. for 20 minutes. The weight of the formulation was recorded before the pasteurization step so that any water that evaporated from the formulation could be replaced. After the pasteurization step, and after any evaporated water had been replaced, the formulation was homogenized at about 160 ° F. in a two-stage homogenizer (Gaulin) using 1500 psi in the first stage and 500 psi in the second stage. The homogenized ice cream formulation was then quickly cooled over a heat transfer board (cooling board) that reduced the temperature of the mix from about 160 degrees F. to about 40 degrees F. The ice cream formulation was then collected in glass jars with lids. If tests were to be performed on the ice cream formulation the glass jars were placed into a refrigerator overnight at a temperature above the freezing point of the ice cream formulation and below 40 degrees F. and then the next day (about 12 to 24 hours later—which gives the stabilizers time to hydrate), the formulation was checked for separation, viscosity and weight (to determine density and overrun) at 40 degrees F. The ice cream formulation was then poured into the cavity of a 2.5 gallon Taylor freezer. If any flavoring agents (such as vanilla) are to be included in the ice cream formulation, they are normally added (i.e., mixed with the ice cream formulation) just before the formulation is poured into the cavity of the freezer. The Taylor freezer was then turned on with the thermostat set to 23 degrees F. As the ice cream formulation was agitated (aerated) and cooled in the Taylor freezer, the weight and temperature of the ice cream formulation was measured and recorded at two minute intervals so that the overrun could be determined. These measurements were taken until the temperature light on the Taylor freezer went off and then turned back on (i.e., one temperature cycle). When the light on the Taylor freezer came back on, samples were taken from the formulation in the Taylor freezer and placed in plastic containers with lids. The plastic containers and their contents were placed in a freezer at ×18 degrees F. for seven (7) days and then the hardness of the resulting ice cream was measured and the extent of syneresis was determined (if any).

The formulations shown in Table 1B were prepared by the process described above.

In formulation number 1 (control), sucrose was added (as a dry ingredient) instead of the maltitol syrup.

In formulation 2, a maltitol syrup according to the present invention is used instead of the sucrose used in the control.

The polyols used in formulation numbers 3, 4, 5, 6 and 7 (i.e., instead of the maltitol syrup), are described below.
Formulation 3 —polydextrose (solid); sorbitol (solid).
Formulation 4 —polydextrose (solid); lactitol (solid).
Formulation 5 —polydextrose (solid); erythritol (solid).
Formulation 6 —polydextrose (solid); isomalt (solid).

Formulation 7 —polydextrose (solid); maltitol (solid).

TABLE 1B
NO SUGAR ADDED ICE CREAM FORMULATIONS
All of the batches have 12% fat.

| | #1 | | | | | | |
|---|---|---|---|---|---|---|---|
| Ingredients | CONTROL | #2 | #3 | #4 | #5 | #6 | #7 |
| 40% Cream | 30 | 30 | 30 | 30 | 30 | 30 | 30 |
| Heavy Whipping | | | | | | | |
| Cream | | | | | | | |
| NFDMS | 9.4 | 10 | 10 | 10 | 10 | 10 | 10 |
| SUCROSE | 15 | 0 | 0 | 0 | 0 | 0 | 0 |
| Maltisweet ™ IC | 0 | 28.53 | 0 | 0 | 0 | 0 | 0 |
| SORBITOL | 0 | 0 | 7.5 | 0 | 0 | 0 | 0 |
| POLYDEXTROSE | 0 | 0 | 7.5 | 7.5 | 7.5 | 7.5 | 7.5 |
| LACTITOL | 0 | 0 | 0 | 7.5 | 0 | 0 | 0 |
| ERYTHRITOL | 0 | 0 | 0 | 0 | 7.5 | 0 | 0 |
| ISOMALT | 0 | 0 | 0 | 0 | 0 | 7.5 | 0 |
| MALTITOL | 0 | 0 | 0 | 0 | 0 | 0 | 7.5 |
| FMC-xp-3548 | 0.45 | 0.45 | 0.45 | 0.45 | 0.45 | 0.45 | 0.45 |
| Water | 45.15 | 31.02 | 44.55 | 44.55 | 44.55 | 44.55 | 44.55 |

| | |
|---|---|
| Note Add 0.5% (30 ml) of Natural & | 6000 Gram Batch |
| Artificial Vanilla Flavor #25653 (David | |
| Michael & Co.) | |
| When freezing the mix | |

The following ice cream formulations A to E can be prepared by a method that is similar to the method described above.

All of the batches have 12% fat.

| Ingredients | A | B |
|---|---|---|
| 40% CREAM | 30 | 30 |
| Heavy Whipping Cream | | |
| NFDMS | 8 | 10 |
| SUCROSE | 0 | 0 |
| Maltisweet ™ MH 80 | 0 | 19.5 |
| Maltisweet ™ IC | 21.4 | 0 |
| FMC-xp-3548 | 0.45 | 0.45 |
| Water | 40.15 | 40.05 |

Batches C and D have 14% fat and Batch E has 12% fat.

| Ingredients | C | D | E |
|---|---|---|---|
| 40% CREAM | 35 | 35 | 30 |
| Heavy Whipping Cream | | | |
| NFDMS | 6 | 6 | 6 |
| Maltisweet ™ IC | 22.5 | 21.4 | 22.5 |
| Cocoa powder | 3.5 | 3.5 | 3.5 |
| FMC-xp-3548 | 0.42 | 0.42 | 0.45 |
| Water | 32.58 | 33.68 | 37.55 |

Table 2A shows a breakdown of the components in some of the maltitol syrups referenced herein and the determination of the average molecular weight (“AMW”) of those maltitol syrups.

TABLE 2A

| | Weight % | Weight % | Weight % | Mol. | | | |
|---|---|---|---|---|---|---|---|
| | (HPLC) | (HPLC) | (HPLC) | Wt. | AMW | AMW | AMW |
| | MS-IC | MH65 | MH80 | MW | MS-IC | MH65 | MH80 |
| Sorbitol | 3.4 | 1.54 | 1.1 | 186 | 6.324 | 2.8644 | 2.046 |
| Mannitol | 0.12 | 0 | 0 | 186 | 0.2232 | 0 | 0 |
| Maltitol | 67.03 | 76.85 | 78.3 | 382 | 256.0546 | 293.567 | 299.106 |
| HP-3 | 16.4 | 3.26 | 2.94 | 558 | 91.512 | 18.1908 | 16.4052 |
| HP-4 | 2 | 0 | 0.49 | 744 | 14.88 | 0 | 3.6456 |
| HP-5 | 2.15 | 0 | 0 | 930 | 19.995 | 0 | 0 |
| HP-6 | 1.22 | 0.39 | 0.72 | 1116 | 13.6152 | 4.3524 | 8.0352 |
| HP-7 | 1.01 | 2.24 | 1.82 | 1302 | 13.1502 | 29.1648 | 23.6964 |
| HP-8 | 0.51 | 0 | 0 | 1488 | 7.5888 | 0 | 0 |
| HP-9 | 0 | 0 | 0 | 1674 | 0 | 0 | 0 |
| HP-10 | 0 | 0 | 0 | 1860 | 0 | 0 | 0 |
| HP-11+ | 5.83 | 15.5 | 14.2 | 2046 | 119.2818 | 317.13 | 290.532 |
| | | | | | 542.6248 | 665.2694 | 643.4664 |
| AMW | 542.6248 | 665.2694 | 643.4664 | | | | |

AMW = Average Molecular Weight (grams/mole)

In certain embodiments of the present invention, the average molecular weight of the solids portion of the maltitol syrup used is important because this property of the maltitol syrup has an effect on the texture of the final ice cream product, especially when the fat content of the ice cream is at a reduced level (e.g., below about 8% by weight, or even more particularly, below about 6% by weight, of the ice cream). A preferred average molecular weight of the solids portion of the maltitol syrup used in the ice cream formulations of the present invention is from about 400 to about 750 grams/mole.

In another preferred embodiment of the present invention, the average molecular weight of the solids portion of the maltitol syrup used is from 500 to 600 grams/mole. Other preferred embodiments of the present invention use maltitol syrups having average molecular weights (solids portion) of from 510 to 580 grams/mole, from 515 to 570 grams/mole, from 520 to 560 grams/mole or from 520 to 550 grams/mole.

Table 2B shows a breakdown of the components in some of the preferred maltitol syrups of the present invention and the determination of the average molecular weight (“AMW”) of those maltitol syrups.

TABLE 2B

| | Weight % | Weight % | Mol. | | |
|---|---|---|---|---|---|
| | (HPLC) | (HPLC) | Wt. | AMW | AMW |
| | LOW | HIGH | MW | LOW | HIGH |
| Sorbitol | 2 | 5 | 186 | 3.72 | 9.3 |
| Mannitol | 0 | 1 | 186 | 0 | 1.86 |
| Maltitol | 62 | 67 | 382 | 236.84 | 255.94 |
| HP-3 | 15 | 20 | 558 | 83.7 | 111.6 |
| HP-4 | 1 | 2 | 744 | 7.44 | 14.88 |
| HP-5 | 1 | 3 | 930 | 9.3 | 27.9 |
| HP-6 | 0 | 2 | 1116 | 0 | 22.32 |
| HP-7 | 0 | 2 | 1302 | 0 | 26.04 |
| HP-8 | 0 | 1 | 1488 | 0 | 14.88 |
| HP-9 | 0 | 1 | 1674 | 0 | 16.74 |
| HP-10 | 0 | 1 | 1860 | 0 | 18.6 |
| HP-11+ | 3 | 10 | 2046 | 61.38 | 204.6 |
| AMW | | | | 402.38 | 724.66 |

AMW = Average Molecular Weight (grams/mole)

In one of the preferred embodiments of the present invention, the maltitol syrup used is Maltisweet™ IC (a product of SPI Polyols, Inc., New Castle, Del.). This syrup can have an average molecular weight (solids portion) of from about 400 to 725 grams/mole (depending on the exact composition of the syrup). Usually, this syrup has an average molecular weight of from about 500 to 550 grams/mole, preferably from 520 to 545 grams/mole.

The use of the maltitol syrups of the type described above in the ice cream formulations of the present invention results in ice creams that have properties that are similar to traditional ice creams that are based on sucrose and/or corn syrup solids as the sweetening component. Further, the amounts of these maltitol syrups that must be used in the ice cream formulations to obtain similar sweetness levels to traditional ice creams is low enough that the freezing point of the ice cream is not reduced significantly. This property of the maltitol syrups described above provides a final ice cream product that is firmer at any given temperature than ice creams made with other polyols or polyol mixtures (i.e., at a similar level of sweetness). Further, since the freezing point of the ice cream formulations of the present invention is higher than formulations made with other polyols or polyol mixtures (i.e., at a similar level of sweetness), this should result in significant savings to the ice cream manufacturer because less energy is expended to freeze the ice cream formulations.

The ice cream formulations of the present invention typically contain from about 10 to 50% by weight (based on the total weight of the ice cream formulation) of the maltitol syrups described above (i.e., when no high-intensity sweeteners are used in the ice cream formulation). It is also possible to use amounts of the preferred maltitol syrups (described above) in any of the ranges described below in the ice cream formulations of the present invention (i.e., when no high-intensity sweeteners are used in the ice cream formulation): 13 to 45% by weight; 16.5 to 45% by weight; 20 to 45% by weight; 18.5 to 40% by weight; and 20 to 38% by weight (all of the above ranges based on the total weight of the ice cream formulation).

When the ice cream formulations of the present invention contain high intensity sweeteners, the amount of the above-described maltitol syrups used is typically reduced to from about 1 to 25% by weight (based on the total weight of the ice cream formulation). It is also possible to use amounts of the preferred maltitol syrups (described above) in any of the ranges described below in the ice cream formulations of the present invention (i.e., when high-intensity sweeteners are used in the ice cream formulation): 2.5 to 20% by weight; 3 to 15% by weight; 2.5 to 10% by weight; and 4 to 10% by weight (all of the above ranges based on the total weight of the ice cream formulation).

The amount of dry solids (including the fat) in the ice cream formulations of the present invention is variable but is usually in the range of from 30% to 50% by weight of the ice cream formulation. Other possible amounts of dry solids in the ice cream formulations of the present invention are: 32 to 50% by weight; 32 to 48% by weight; 34 to 46% by weight; and 35 to 45% by weight (all of the above ranges based on the total weight of the ice cream formulation).

The calculated amounts of water and dry solids for some of the ice cream formulations of the present invention are provided below in Table 2C. Table 2C also shows the calculated amount of lactose (dry solids basis) in those formulations.

TABLE 2C

| | | | LACTOSE |
|---|---|---|---|
| | DRY SOLIDS | WATER | (% by weight - |
| Formulation | (% by weight) | (% by weight) | based on dry solids) |
| 2 | 45.14 | 54.86 | 13 |
| A | 37.85 | 62.15 | 12.9 |
| C | 42.47 | 57.53 | 9.5 |
| D | 41.65 | 58.35 | 9.6 |
| E | 40.23 | 59.77 | 9.6 |
| 8 | 35.56 | 64.44 | 14.5 |
| 9 | 37.78 | 62.22 | 14 |
| 10 | 40.04 | 59.96 | 13.6 |
| 11 | 34.01 | 65.99 | 15.1 |

The non-fat dry milk solids (NFDMS) used in the ice cream formulations of the present invention contained about 50% by weight lactose, based on the dry solids contained in the NFDMS.

The 40% cream (heavy whipping cream) used in the ice cream formulations of the present invention contained about 45.3% by weight solids with the remainder being water. The solids in the cream were fat (40% by weight of the cream); lactose (2.9% by weight of the cream); and other milk solids (2.4% by weight of the cream).

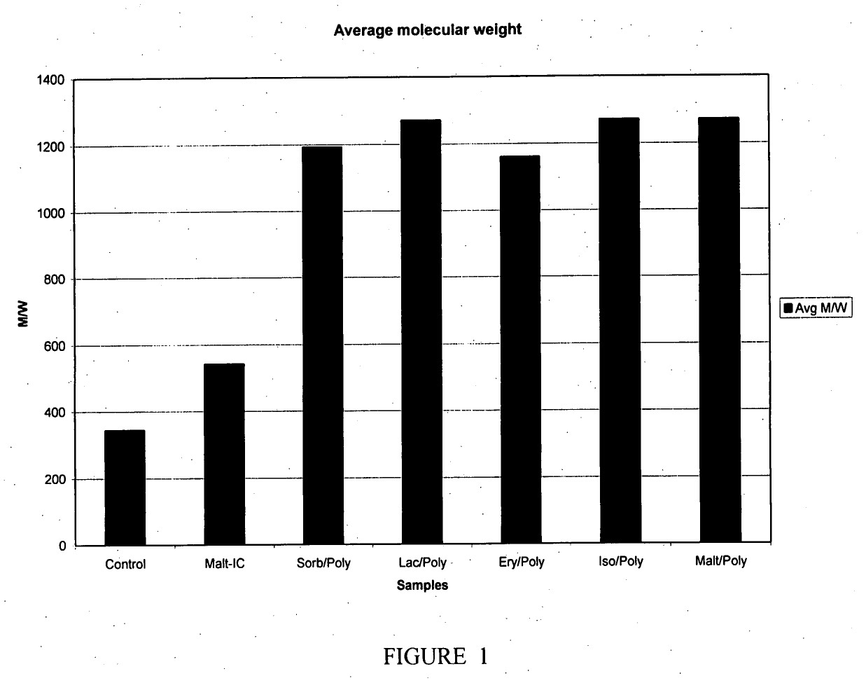

As shown in FIG. 1, of the seven sweeteners used to prepare the formulations 1 to 7 (described above), Maltisweet™ IC has an average molecular weight that is the most similar to the control, which is sucrose. It is believed that this similarity in the average molecular weight between Maltisweet™ IC and sucrose is at least partially responsible for the excellent properties demonstrated by the ice cream formulations of the present invention, including the similarities in sweetness and mouthfeel between ice creams made from the formulations of the present invention and commercial ice creams containing sweetening compositions that are based primarily or completely on sucrose.

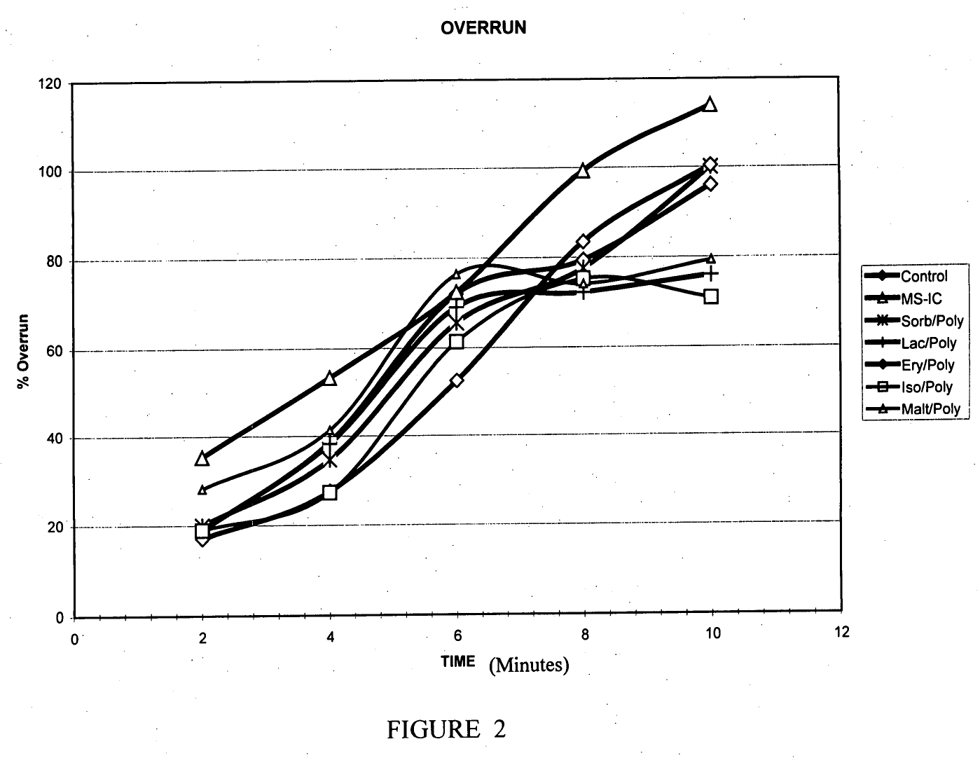

FIG. 2 shows the overrun of the ice cream formulations 1 to 7, described above, as it develops over time (i.e., the time that the ice cream formulations are being aerated). The data used to generate FIG. 2 are shown below in Table 5. Overrun is the amount of air incorporated into an ice cream and is usually expressed as “% overrun”. The percent overrun is determined by the increase in volume of the final ice cream formulation caused by the aeration step. The increase in volume of the mix (fmal volume of the mix after aeration minus the initial volume of the mix before aeration) is divided by the initial volume of the mix and then multiplied by 100 to get a percentage. As shown in FIG. 2, the ice cream formulation made with Maltisweet™ IC not only has the greatest overrun of any of the ice cream formulations tested, it also reaches 100% overrun faster than any of the other formulations. This should result in a substantial savings of time and energy in the commercial manufacture of ice creams based on this formulation. It is believed that these properties are due, at least in part, to the average molecular weight of Maltisweet™ IC (which is similar to the control, sucrose).

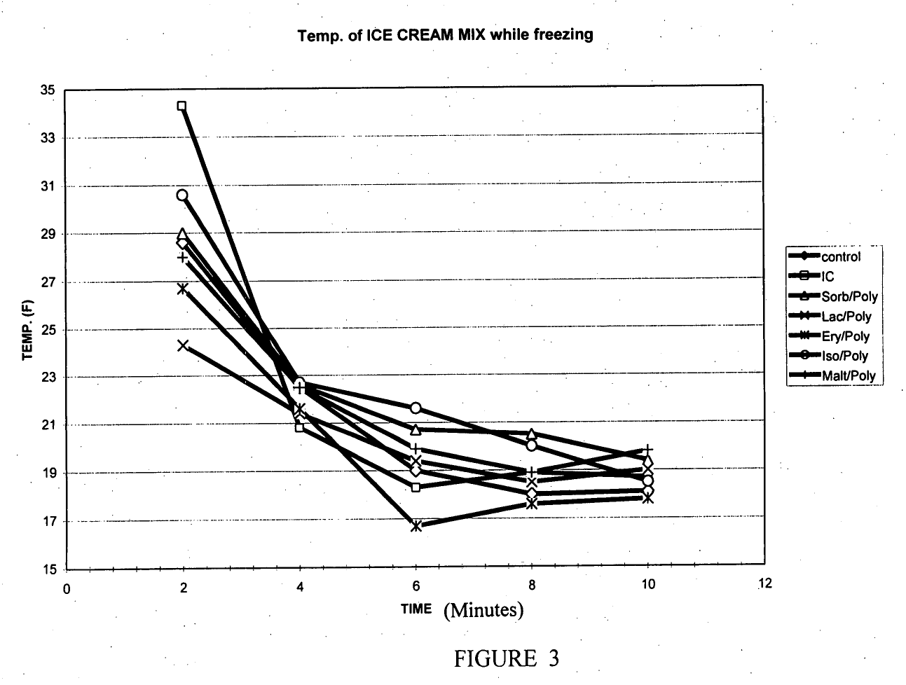

FIG. 3 shows the temperature of the ice cream mixes or formulations (i.e., formulations 1 to 7, described above) over time as they are freezing. The data used to generate FIG. 3 are shown below as Table 6.

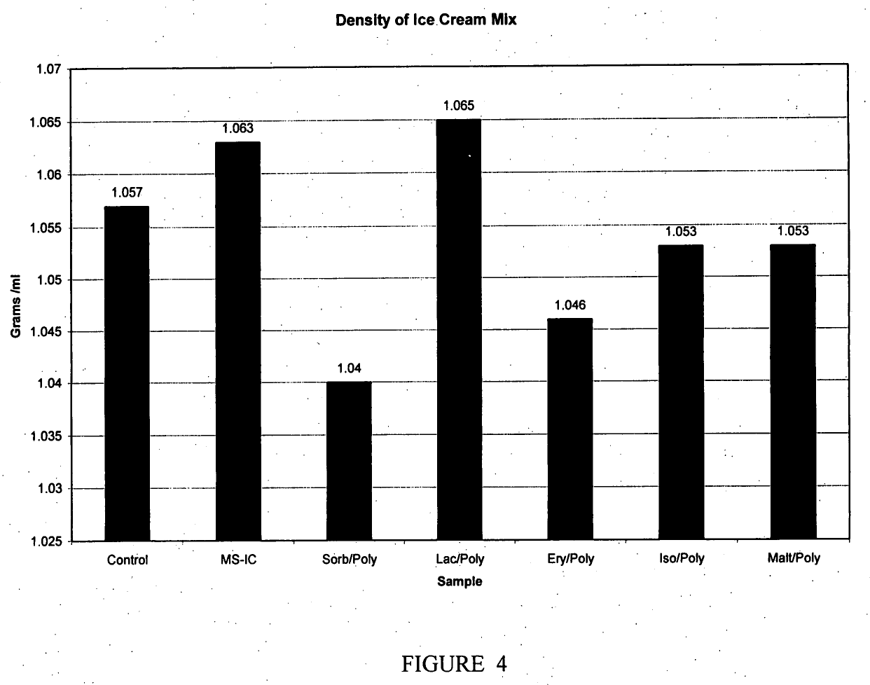

FIG. 4 shows the density of the ice cream mixes or formulations described above (i.e., formulations 1 to 7). The densities were measured prior to freezing and aeration. The differences in the densities of the formulations did not seem to have a significant impact on the freezing or overrun of the formulations.

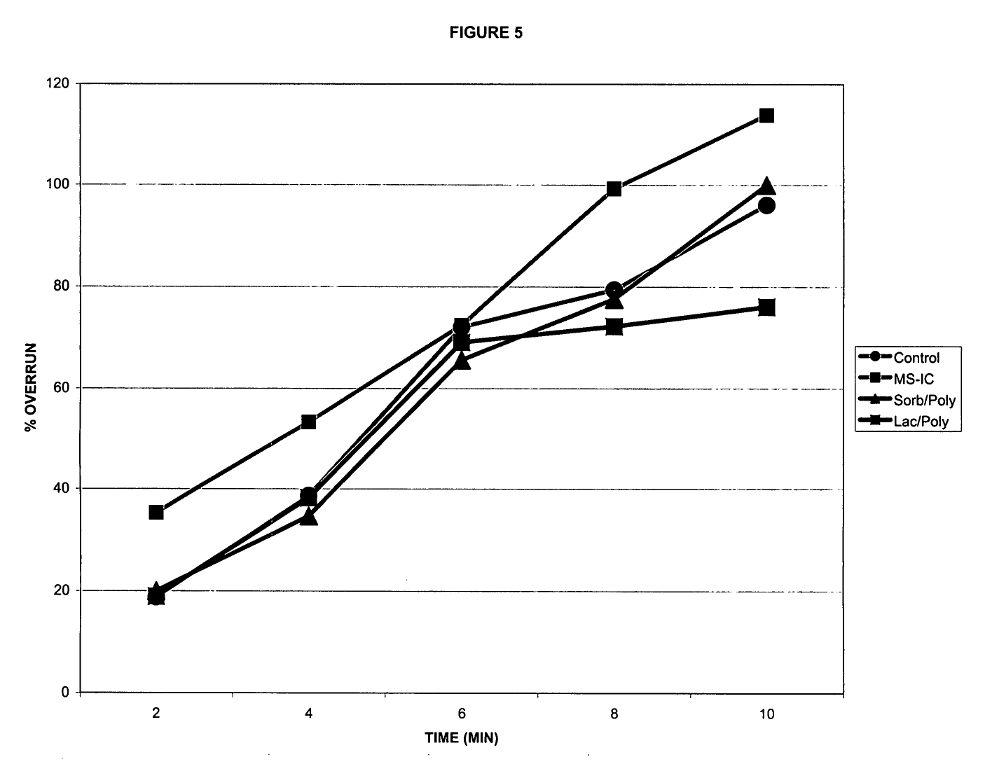

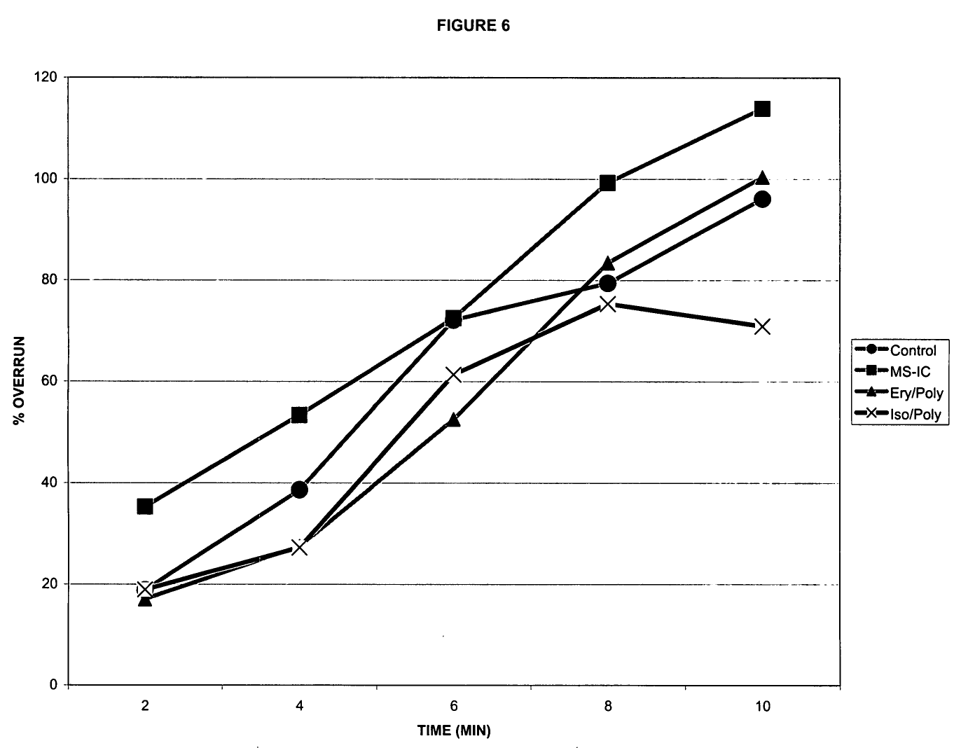

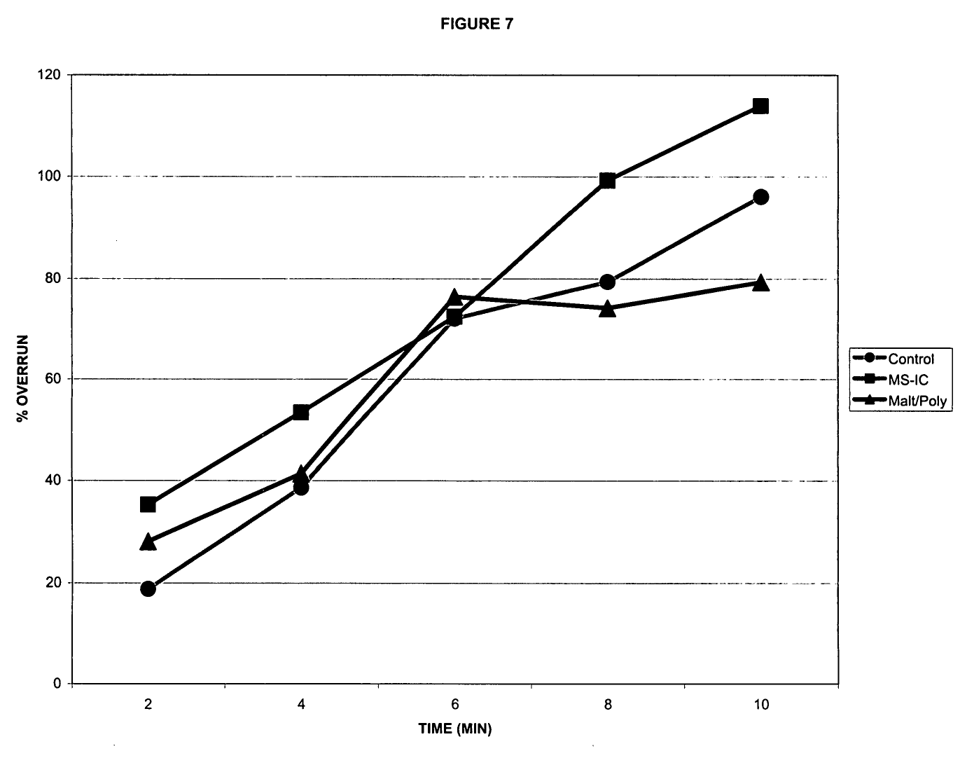

FIGS. 5, 6 and 7 show the same information as FIG. 2 but with fewer formulations per graph.

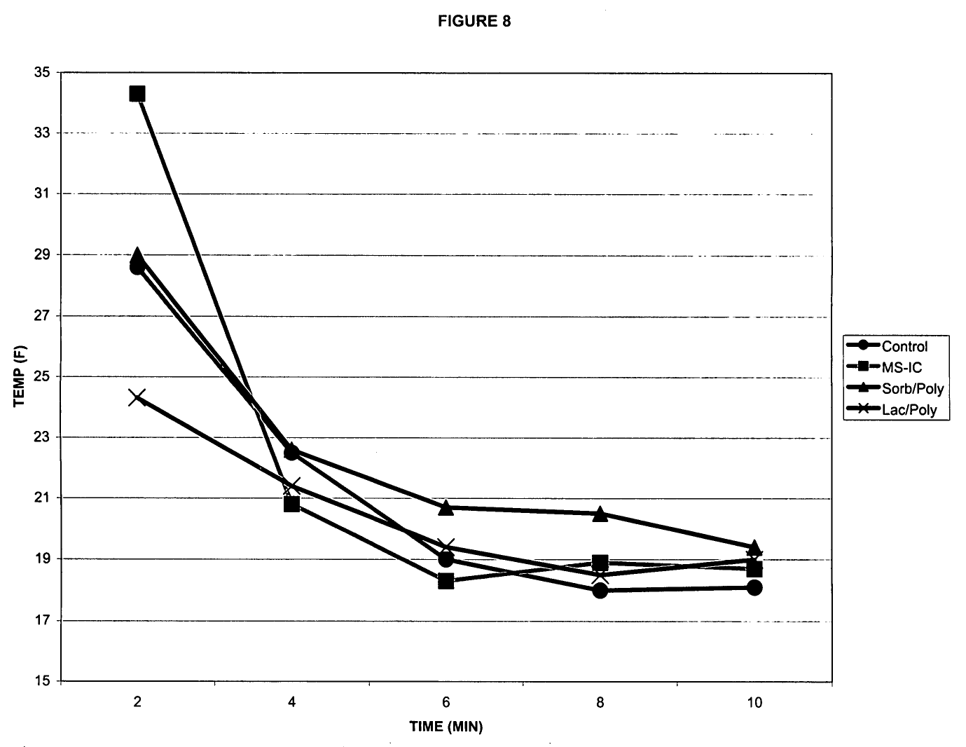

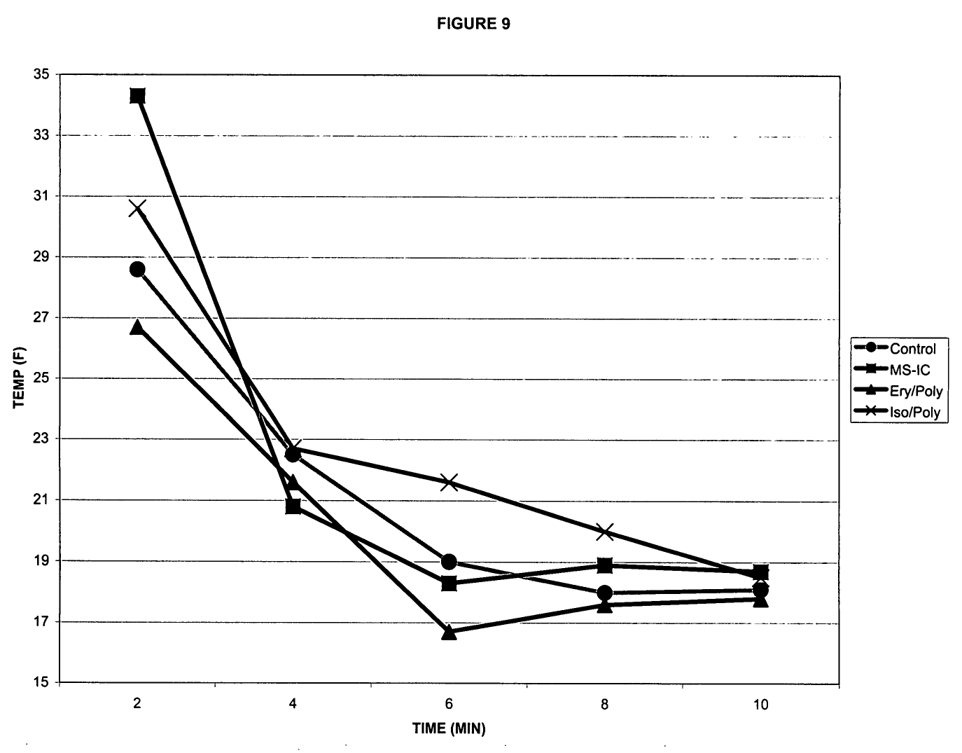

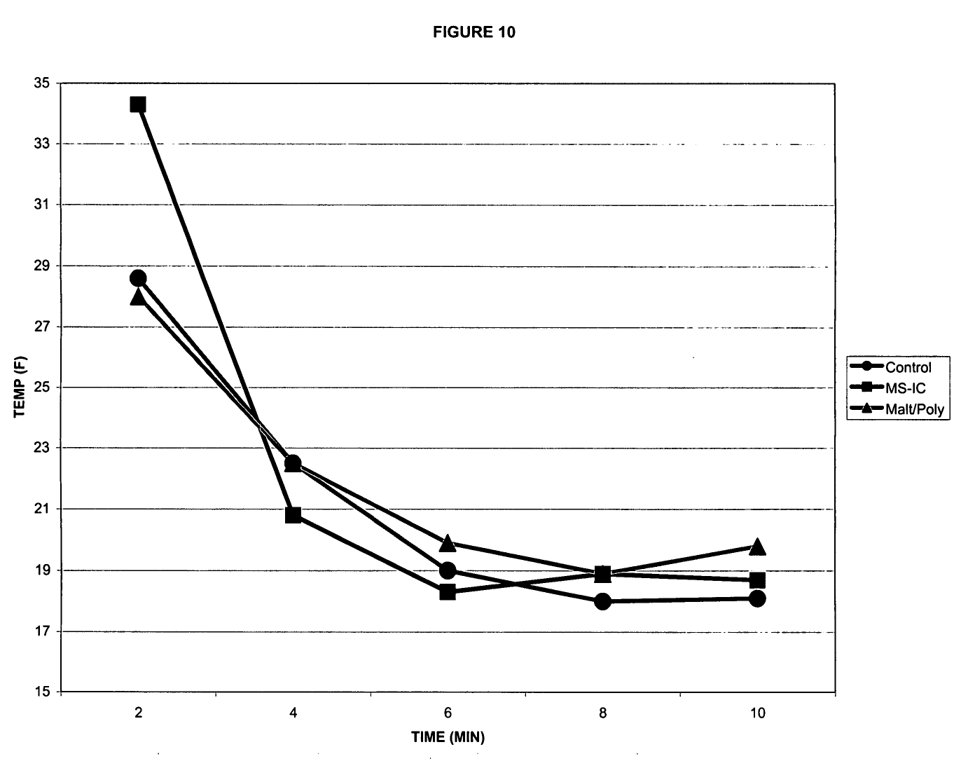

FIGS. 8, 9 and 10 show the same information as FIG. 3 but with fewer formulations per graph.

Table 3 shows three ice cream formulations of the present invention that were made by the method described below.

The ice cream formulations of Table 3 were prepared by first mixing the wet ingredients: 40% fat dairy cream (a heavy whipping cream), a maltitol syrup (Maltisweet™ IC—about 75% solids containing about 65% by weight maltitol) and water and then slowly adding the dry ingredients to the wet ingredients while mixing. The dry ingredients were non-fat dry milk solids (NFDMS) and a stabilizer (microcrystalline cellulose—xp-3548 from FMC). After the addition of the dry ingredients, the formulation was mixed for about 10-15 minutes with a high speed mixer to ensure that the formulation was homogeneous. After the mixing step, the formulation was pasteurized in an HTST (high temperature short time) tubular heat exchanger (Microthermics) at about 180 degrees F. for 30 seconds. After the pasteurization step, the formulation was homogenized at about 160 ° F. in a two-stage homogenizer (Gaulin) using 1500 psi in the first stage and 500 psi in the second stage. The homogenized ice cream formulation was then collected in glass jars with lids. If tests were to be performed on the ice cream formulation the glass jars were placed into a refrigerator overnight at a temperature above the freezing point of the ice cream formulation and below 40 degrees F. and then the next day (about 12 to 24 hours later—which gives the stabilizers time to hydrate), the formulation was checked for separation, viscosity and weight (to determine density and overrun) at about 40 degrees F. The ice cream formulation was then poured into the cavity of a 2.5 gallon Taylor freezer. If any flavoring agents (such as vanilla) are to be included in the ice cream formulation, they are normally added (i.e., mixed with the ice cream formulation) just before the formulation is poured into the cavity of the freezer. The Taylor freezer is then turned on with the thermostat set to 23 degrees F. As the ice cream formulation is agitated (aerated) and cooled in the Taylor freezer, the weight and temperature of the ice cream formulation is measured and recorded at two minute intervals so that the overrun can be determined. These measurements are taken until the temperature light on the Taylor freezer goes off and then turns back on (i.e., one temperature cycle). When the light on the Taylor freezer comes back on, samples are taken from the formulation in the Taylor freezer and placed in plastic containers with lids. The plastic containers and their contents are placed in a freezer at ×18 degrees F. for seven (7) days and then the hardness of the resulting ice cream is measured and the extent of syneresis is determined (if any).

TABLE 3
NO SUGAR ADDED ICE CREAM FORMULATIONS

| | #8 | #9 | #10 |
|---|---|---|---|
| Ingredients | 2% Butterfat | 4% Butterfat | 6% Butterfat |
| 40% Cream | 5.00 | 10.00 | 15.00 |
| Heavy Whipping Cream | | | |
| NFDMS | 10.00 | 10.00 | 10.00 |
| Maltisweet ™ IC | 30.60 | 30.60 | 30.60 |
| Stabilizer/Emulsifier | 0.65 | 0.60 | 0.60 |
| (xp-3548 from FMC) | | | |
| Water | 53.75 | 48.80 | 43.80 |
| Total | 100 | 100 | 100 |

Note
Add 0.5% (30 ml) of Natural & Artificial Vanilla Flavor #25653 (David Michael & Co.) When freezing the mix

Sensory evaluation of ice cream made from formulation #8, in comparison to a similar ice cream made with 7.5% sorbitol and 7.5% polydextrose determined that the formulation #8 ice cream had a much better texture (i.e., “creaminess mouthfeel”) than the comparison ice cream.

Sensory evaluation of ice cream made from formulation #9, in comparison to a similar ice cream made with 7.5% sorbitol and 7.5% polydextrose determined that the formulation #9% ice cream had a much better texture (i.e., “creaminess mouthfeel”) and a better mouth coating sensation (“smoothness mouthfeel”) than the comparison ice cream.

Sensory evaluation of the ice cream made from formulation #10, in comparison to a similar ice cream made with 7.5% sorbitol and 7.5% polydextrose, determined that the formulation #10 ice cream had a much better texture (i.e., “creaminess mouthfeel”) and a better mouth coating sensation (“smoothness mouthfeel”) than the comparison ice cream.

Table 4 shows an additional ice cream formulation of the present invention (formulation #11) and three comparison ice cream formulations #12, #13 and #14, all produced by the same method as the ice cream formulations of Table 3 and all containing 2% butterfat.

TABLE 4
NO SUGAR ADDED ICE CREAM FORMULATIONS
All of the batches have 2% butterfat.

| Ingredients | #11 | #12 | #13 | #14 |
|---|---|---|---|---|
| 40% Cream | 5.00 | 5.00 | 5.00 | 5.00 |
| Heavy Whipping Cream | | | | |
| NFDMS | 10.00 | 10.00 | 10.00 | 10.00 |
| SUCROSE (powder) | 0 | 15.00 | 0 | 0 |
| Maltisweet ™ IC | 28.53 | 0 | 0 | 0 |
| SORBITOL (powder) | 0 | 0 | 7.50 | 0 |
| POLYDEXTROSE | 0 | 0 | 7.50 | 7.50 |
| (powder) | | | | |
| MALTITOL (powder) | 0 | 0 | 0 | 7.50 |
| Stabilizer/Emulsifier | 0.65 | 0.65 | 0.65 | 0.65 |
| (FMC-xp-3548) | | | | |
| Water | 55.82 | 69.35 | 69.35 | 69.35 |
| Total | 100 | 100 | 100 | 100 |

| | |
|---|---|
| Note Add 0.5% (30 ml) of | 7500 Gram Batch |
| Natural & Artificial Vanilla | |
| Flavor #25653 | |
| (David Michael & Co.) | |
| When Freezing the mix | |

Sensory evaluation of ice creams made from formulations #11 to #14 determined that the formulation #11 ice cream had better textural characteristics and better flavor release. Specifically, the formulation #12 ice cream was very icy (i.e., there was a noticeable presence of ice crystals which reduced the smoothness mouthfeel of the ice cream) and grainy and had a flavor release (vanilla) that was inferior to the formulation #11 ice cream. The formulation #13 and #14 ice creams were also very icy and had poor flavor release. In contrast, the formulation #11 ice cream was smooth and creamy and had good flavor release.

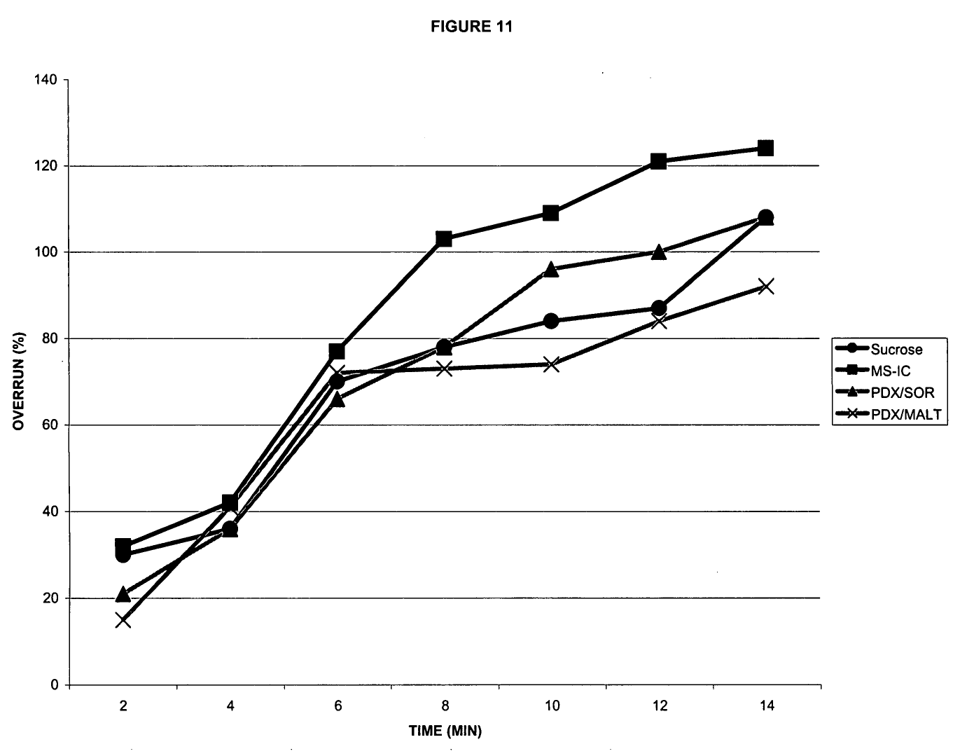

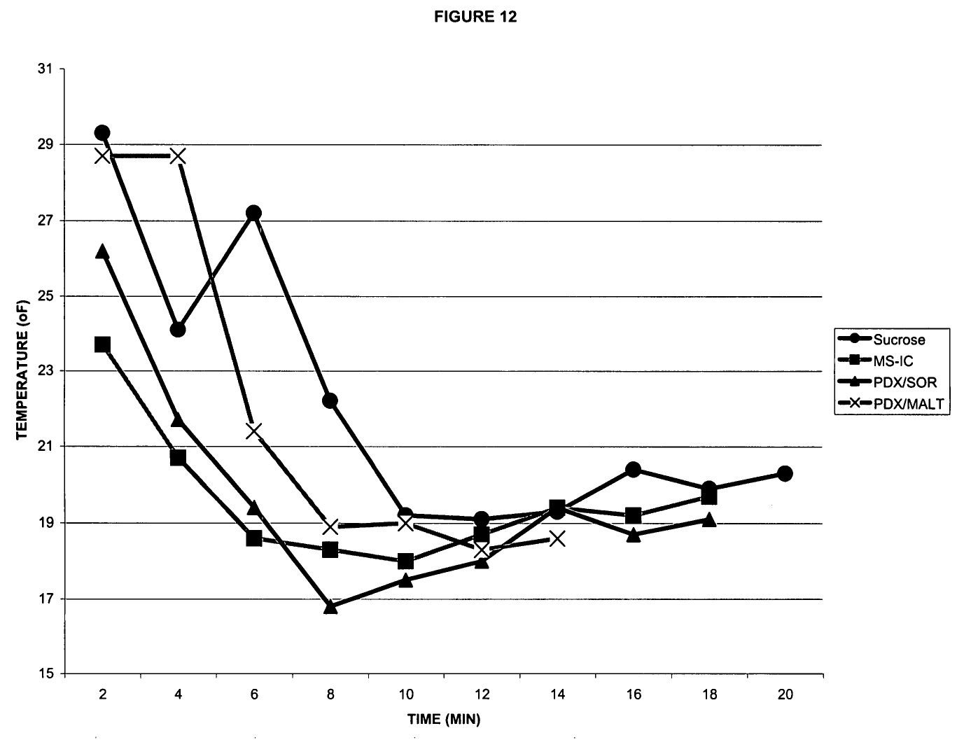

In addition to the sensory evaluation described above, the ice cream formulations of Table 4 were also evaluated to determine the percent overrun and the temperature of the formulation while freezing. The results of these evaluations are shown in FIGS. 11 and 12. As shown in FIG. 11, the ice cream made from formulation #11 not only has the greatest overrun of any of these ice cream formulations, it also reaches 100% overrun faster than any of the other formulations. As discussed earlier, this should result in a substantial savings of time and energy in the commercial manufacture of ice creams based on this formulation.

As shown in FIGS. 3 and 12, the formulations of the present invention (using Maltisweet™ IC) also have the desirable property of being easily and rapidly cooled to freezing temperatures. This should allow additional savings by reducing the amount of energy that needs to be expended in cooling the ice cream formulations after the pasteurization and homogenization steps.

The data used to generate FIGS. 11 and 12 are shown below in Tables 7 and 8.

TABLE 5
Data for FIG. 2 (formulations #1 to #7)

| | Form. #1 | | | | | | |
|---|---|---|---|---|---|---|---|
| | % Overrun | Form. #2 | Form. #3 | Form. #4 | Form. #5 | Form. #6 | Form. #7 |
| Time | Sucrose | % Overrun | % Overrun | % Overrun | % Overrun | % Overrun | % Overrun |
| (min) | (Control) | MS-IC | Sorb/Poly | Lac/Poly | Ery/Poly | Iso/Poly | Malt/Poly |
| 2 | 18.83 | 35.29 | 20 | 18.92 | 17.03 | 18.91 | 28.10 |
| 4 | 38.64 | 53.33 | 34.66 | 38.25 | 27.46 | 27.21 | 41.34 |
| 6 | 72.10 | 72.5 | 65.64 | 69.11 | 52.53 | 61.36 | 76.45 |
| 8 | 79.41 | 99.28 | 77.63 | 72.27 | 83.45 | 75.32 | 74.20 |
| 10 | 96.07 | 113.95 | 100 | 76.11 | 100.37 | 70.94 | 79.34 |

TABLE 6
Data for FIG. 3 (formulations #1 to #7)

| | Form. #1 | | | | | | |
|---|---|---|---|---|---|---|---|
| | Temp (° F.) | Form. #2 | Form. #3 | Form. #4 | Form. #5 | Form. #6 | Form. #7 |
| Time | Sucrose | Temp (° F.) | Temp (° F.) | Temp (° F.) | Temp (° F.) | Temp (° F.) | Temp (° F.) |
| (minutes) | (Control) | MS-IC | Sorb/Poly | Lac/Poly | Ery/Poly | Iso/Poly | Malt/Poly |
| 2 | 28.6 | 34.3 | 29 | 24.3 | 26.7 | 30.6 | 28 |
| 4 | 22.5 | 20.8 | 22.6 | 21.4 | 21.6 | 22.7 | 22.5 |
| 6 | 19 | 18.3 | 20.7 | 19.4 | 16.7 | 21.6 | 19.9 |
| 8 | 18 | 18.9 | 20.5 | 18.5 | 17.6 | 20 | 18.9 |
| 10 | 18.1 | 18.7 | 19.4 | 19 | 17.8 | 18.5 | 19.8 |

TABLE 7
Data for FIG. 11 (formulations #11 to #14)

| | | Form. #12 | | |
|---|---|---|---|---|
| | Form. #11 | % Overrun | Form. #13 | Form. #14 |
| Time | % Overrun | Sucrose | % Overrun | % Overrun |
| (min) | MS-IC | (control) | PDX/Sorb | PDX/Malt |
| 2 | 32 | 30 | 21 | 15 |
| 4 | 42 | 36 | 36 | 41 |
| 6 | 77 | 70 | 66 | 72 |
| 8 | 103 | 78 | 78 | 73 |
| 10 | 109 | 84 | 96 | 74 |
| 12 | 121 | 87 | 100 | 84 |
| 14 | 124 | 108 | 108 | 92 |

TABLE 8
Data for FIG. 12 (formulations #11 to #14)

| | | Form. #12 | | |
|---|---|---|---|---|
| | Form. #11 | Temp (° F.) | Form. #13 | Form. #14 |
| Time | Temp (° F.) | Sucrose | Temp (° F.) | Temp (° F.) |
| (min) | MS-IC | (control) | PDX/Sorb | PDX/Malt |
| 2 | 23.7 | 29.3 | 26.2 | 28.7 |
| 4 | 20.7 | 24.1 | 21.7 | 28.7 |
| 6 | 18.6 | 27.2 | 19.4 | 21.4 |
| 8 | 18.3 | 22.2 | 16.8 | 18.9 |
| 10 | 18 | 19.2 | 17.5 | 19 |
| 12 | 18.7 | 19.1 | 18 | 18.3 |
| 14 | 19.4 | 19.3 | 19.4 | 18.6 |
| 16 | 19.2 | 20.4 | 18.7 | |
| 18 | 19.7 | 19.9 | 19.1 | |
| 20 | | 20.3 | | |

While the invention has been particularly shown and described with reference to preferred embodiments thereof, it will be understood by those skilled in the art that various changes in form and details may be made without departing from the spirit and scope of the invention.

What is claimed is:

1. An ice cream formulation comprising dry solids, wherein said ice cream formulation comprises:
a) fat in an amount of from 0 to 15% by weight, based on the total weight of the ice cream formulation;
b) non-fat milk solids in an amount of from 6 to 12% by weight, based on the total weight of the ice cream formulation; and
c) maltitol in an amount of from 30 to 45% by weight, based on the weight of the dry solids in the ice cream formulation.

2. An ice cream formulation comprising dry solids, wherein said ice cream formulation comprises:
a) fat in an amount of from 0 to 8% by weight, based on the total weight of the ice cream formulation;
b) non-fat milk solids in an amount of from 6 to 12% by weight, based on the total weight of the ice cream formulation; and
c) maltitol in an amount of from 20 to 45% by weight, based on the weight of the dry solids in the ice cream formulation.

3. The ice cream formulation of claim 2, wherein the maltitol is present in an amount of from 30 to 45% by weight, based on the weight of the dry solids in the ice cream formulation.

4. An ice cream formulation comprising dry solids, wherein said ice cream formulation comprises:
a) fat in an amount of from 9 to 15% by weight, based on the total weight of the ice cream formulation;
b) non-fat milk solids in an amount of from 6 to 12% by weight, based on the total weight of the ice cream formulation; and
c) maltitol in an amount of from 20 to 45% by weight, based on the weight of the dry solids in the ice cream formulation.

5. The ice cream formulation of claim 4, wherein the maltitol is present in an amount of from 30 to 45% by weight, based on the weight of the dry solids in the ice cream formulation.

6. The ice cream formulation of claim 1, further comprising: one or more stabilizers and flavoring agents.

7. The ice cream formulation of claim 1, further comprising from 0.1 to 0.5% by weight of one or more stabilizers, wherein the weight percent of said one or more stabilizers is based on the weight of the solids present in the ice cream formulation.

8. The ice cream formulation of claim 1, wherein said ice cream formulation contains either no added sucrose or from 0.01 to 2% added sucrose.

9. Ice cream comprising:
a) fat in an amount of from 0 to 15% by weight, based on the total weight of the ice cream formulation;
b) non-fat milk solids in an amount of from 6 to 12% by weight, based on the total weight of the ice cream formulation; and
c) maltitol in an amount of from 30 to 45% by weight, based on the weight of the dry solids in the ice cream formulation.

10. Ice cream comprising:
a) fat in an amount of from 0 to 8% by weight, based on the total weight of the ice cream formulation;
b) non-fat milk solids in an amount of from 6 to 12% by weight, based on the total weight of the ice cream formulation; and
c) maltitol in an amount of from 20 to 45% by weight, based on the weight of the dry solids in the ice cream formulation.

11. The ice cream of claim 10, wherein the maltitol is present in an amount of from 30 to 45% by weight, based on the weight of the dry solids in the ice cream formulation.

12. Ice cream comprising:
a) fat in an amount of from 9 to 15% by weight, based on the total weight of the ice cream formulation;
b) non-fat milk solids in an amount of from 6 to 12% by weight, based on the total weight of the ice cream formulation; and
c) maltitol in an amount of from 20 to 45% by weight, based on the weight of the dry solids in the ice cream formulation.

13. The ice cream formulation of claim 12, wherein the maltitol is present in an amount of from 30 to 45% by weight, based on the weight of the dry solids in the ice cream formulation.

14. The ice cream of claim 9, further comprising: one or more stabilizers and flavoring agents.

15. The ice cream of claim 9, further comprising from 0.1 to 0.5% by weight of one or more stabilizers, wherein the weight percent of said one or more stabilizers is based on the weight of the solids present in the ice cream.

16. The ice cream of claim 9, wherein said ice cream contains either no added sucrose or from 0.01 to 2% added sucrose.

17. The ice cream formulation of claim 1, wherein the ice cream formulation contains a high-intensity sweetener and from about 4% to 20% by weight maltitol on a dry solids basis.

18. The ice cream of claim 9, wherein the ice cream contains a high-intensity sweetener and from about 4% to 20% by weight maltitol on a dry solids basis.
